(19) United States
(12) Patent Application Publication
(10) Pub. No.: US 2021/0405616 A1
(43) Pub. Date: Dec. 30, 2021

(54) SCENARIO PROVIDING SYSTEM, SCENARIO PROVIDING DEVICE, SCENARIO EXECUTION TERMINAL, SCENARIO PROVIDING METHOD, SCENARIO EXECUTION METHOD AND PROGRAM

(71) Applicant: NTT Advanced Technology Corporation, Kawasaki-shi, Kanagawa (JP)

(72) Inventors: Akinori YAMAMOTO, Kawasaki-shi (JP); Takashi HATTORI, Kawasaki-shi (JP); Akiko NOGUCHI, Kawasaki-shi (JP); Shuichi MIYAZAKI, Kawasaki-shi (JP)

(73) Assignee: NTT Advanced Technology Corporation, Kawasaki-shi, Kanagawa (JP)

(21) Appl. No.: 17/289,160

(22) PCT Filed: Dec. 4, 2019
(86) PCT No.: PCT/JP2019/047429

§ 371 Date: Apr. 27, 2021

(30) Foreign Application Priority Data
Jan. 11, 2019 (JP) 2019-003248

(51) Int. Cl. G05B 19/4155; G06Q 30/04; G06F 16/13

(52) U.S. Cl. CPC G05B 19/4155; G06Q 30/04; G05B 2219/36017; G05B 2219/33125; G05B 2219/36127; G06F 16/13

(57) ABSTRACT

A scenario providing device stores a scenario file, a customization file for stating a setting value of a variable used for executing a process constituting a scenario, and a menu for selecting the scenario. A menu providing unit of the scenario providing device causes a scenario execution terminal to display the menu and decides the scenario in accordance with an option selected in the scenario execution terminal from options included in the displayed menu. The scenario providing unit of the scenario providing device transmits the scenario file of the decided scenario and the customization file. A scenario execution unit of the scenario execution terminal substitutes, in the scenario indicated by the scenario file, the setting value of the variable stated in the customization file by a user and executes the scenario.

### TECHNICAL FIELD

The present invention relates to a scenario providing system, a scenario providing device, a scenario execution terminal, a scenario providing method, a scenario execution method and a program.

Priority is claimed on Japanese Patent Application No. 2019-3248, filed Jan. 11, 2019, the content of which is incorporated herein by reference.

### BACKGROUND ART

Robotic process automation (RPA) is a technology enabling automatic execution of typical work that has been manually performed using an information processing device such as a personal computer (PC). For example, a scenario in which a work procedure is stated is created (for example, refer to Patent Document 1), and the work which has been manually performed is reproduced by causing the PC to execute the scenario (for example, refer to Patent Document 2). RPA can eliminate a time cost and a labor cost and reduce work mistakes.

### PRIOR ART DOCUMENTS

### Patent Documents

### Patent Document 1

Japanese Patent No. 5026451

### Patent Document 2

Japanese Patent No. 4883638

### SUMMARY OF INVENTION

### Problems to be Solved by Invention

Among potential users considering introduction of RPA, there are also users who hesitate to introduce RPA due to concerns about the difficulty of creating scenarios. In addition, among users who have already introduced RPA, there are users who desire to reduce a load of scenario creation.

In view of the above matter, an object of the present invention is to provide a scenario providing system, a scenario providing device, a scenario execution terminal, a scenario providing method, a scenario execution method, and a program enabling a user to easily prepare a scenario of RPA.

### Means for Solving the Problems

A scenario providing system of one aspect of the present invention includes a scenario providing device and a scenario execution terminal. The scenario providing device includes a storage unit configured to store a scenario file in which a scenario indicating a procedure of a process in the scenario execution terminal is stated, a customization file for stating a setting value of a variable used for executing the process constituting the scenario stated in the scenario file, and a menu for selecting the scenario, a menu providing unit configured to cause the scenario execution terminal to display the menu and decide the scenario in accordance with the option selected in the scenario execution terminal from options included in the displayed menu, and a scenario providing unit configured to transmit the scenario file of the scenario decided by the menu providing unit and the customization file to the scenario execution terminal. The scenario execution terminal includes a scenario selection unit configured to display the menu received from the scenario providing device on a display unit and notify the scenario providing device of the option selected from the menu, a scenario reception unit configured to receive the scenario file and the customization file from the scenario providing device, a customization file editing unit configured to perform editing of setting a value of the variable in the customization file in accordance with an input provided by a user, and a scenario execution unit configured to substitute, in the scenario indicated by the scenario file, the setting value of the variable stated in the customization file and execute the scenario in which the setting value is substituted.

In the scenario providing system of one aspect of the present invention, the customization file may include a statement of a description related to the setting value of the variable.

In the scenario providing system of one aspect of the present invention, in the menu, one or more of a function of the scenario, an application implementing a function used in the scenario in the scenario execution terminal, an execution environment of the scenario in the scenario execution terminal, and an external service used in the scenario may be used as the options.

In the scenario providing system of one aspect of the present invention, the scenario execution terminal may further include a log output unit configured to output log data indicating execution of a predetermined process included in the scenario or an execution result of the scenario to the scenario providing device.

In the scenario providing system of one aspect of the present invention, the scenario providing device may further include a billing unit configured to perform billing based on the log data received from the scenario execution terminal.

A scenario providing device of one aspect of the present invention is included in a scenario providing system which includes a scenario execution terminal. The scenario providing device includes a storage unit configured to store a scenario file in which a scenario indicating a procedure of a process in the scenario execution terminal is stated, a customization file for stating a setting value of a variable used for executing the process constituting the scenario stated in the scenario file, and a menu for selecting the scenario, a menu providing unit configured to cause the scenario execution terminal to display the menu and decide the scenario in accordance with the option selected in the scenario execution terminal from options included in the displayed menu, and a scenario providing unit configured to transmit the scenario file of the scenario decided by the menu providing unit and the customization file to the scenario execution terminal.

A scenario execution terminal of one aspect of the present invention is included in a scenario providing system which includes a scenario providing device. The scenario execution terminal includes a scenario selection unit configured to receive a menu for selecting a scenario indicating a procedure of a process in the scenario execution terminal from the scenario providing device, display the menu on a display unit, and notify the scenario providing device of an option selected from the menu, a scenario reception unit configured to receive, from the scenario providing device, a scenario file in which the scenario decided in accordance with the option is stated, and a customization file for stating a setting value of a variable used for executing the process constituting the scenario stated in the scenario file, a customization file editing unit configured to perform editing of setting a value of the variable in the customization file in accordance with an input provided by a user, and a scenario execution unit configured to substitute, in the scenario indicated by the scenario file, the setting value of the variable stated in the customization file and execute the scenario in which the setting value is substituted.

A scenario providing method of one aspect of the present invention is executed by a scenario providing system including a scenario providing device and a scenario execution terminal. The scenario providing device includes a storage unit configured to store a scenario file in which a scenario indicating a procedure of a process in the scenario execution terminal is stated, a customization file for stating a setting value of a variable used for executing the process constituting the scenario stated in the scenario file, and a menu for selecting the scenario. The scenario providing method includes, the steps executed by the scenario providing device of, a menu providing step of causing the scenario execution terminal to display the menu and deciding the scenario in accordance with the option selected in the scenario execution terminal from options included in the displayed menu, and a scenario providing step of transmitting the scenario file of the scenario decided in the menu providing step and the customization file to the scenario execution terminal, and scenario providing method includes, the steps executed by the scenario execution terminal of, a scenario selection step of displaying the menu received from the scenario providing device on a display unit and notifying the scenario providing device of the option selected from the menu, a scenario reception step of receiving the scenario file and the customization file from the scenario providing device, a customization file editing step of performing editing of setting a value of the variable in the customization file in accordance with an input provided by a user, and a scenario execution step of substituting, in the scenario indicated by the scenario file, the setting value of the variable stated in the customization file and executing the scenario in which the setting value is substituted.

A scenario providing method of one aspect of the present invention is executed by a scenario providing device in a scenario providing system including the scenario providing device and a scenario execution terminal. The scenario providing device includes a storage unit configured to store a scenario file in which a scenario indicating a procedure of a process in the scenario execution terminal is stated, a customization file for stating a setting value of a variable used for executing the process constituting the scenario stated in the scenario file, and a menu for selecting the scenario. The scenario providing method includes, the steps executed by the scenario providing device of, a menu providing step of causing the scenario execution terminal to display the menu and deciding the scenario in accordance with the option selected in the scenario execution terminal from options included in the displayed menu, and a scenario providing step of transmitting the scenario file of the scenario decided in the menu providing step and the customization file to the scenario execution terminal.

A scenario execution method of one aspect of the present invention is executed by a scenario execution terminal in a scenario providing system including a scenario providing device and the scenario execution terminal. The scenario execution method includes a scenario selection step of receiving a menu for selecting a scenario indicating a procedure of a process in the scenario execution terminal from the scenario providing device, displaying the menu on a display unit, and notifying the scenario providing device of an option selected from the menu, a scenario reception step of receiving, from the scenario providing device, a scenario file in which the scenario decided in accordance with the option is stated, and a customization file for stating a setting value of a variable used for executing the process constituting the scenario stated in the scenario file, a customization file editing step of performing editing of setting a value of the variable in the customization file in accordance with an input provided by a user, and a scenario execution step of substituting, in the scenario indicated by the scenario file, the setting value of the variable stated in the customization file and executing the scenario in which the setting value is substituted.

A program of one aspect of the present invention causes a computer to function as the scenario providing device.

A program of one aspect of the present invention causes a computer to function as the scenario execution terminal.

### Advantageous Effects of Invention

According to the present invention, a user can easily prepare a scenario of RPA.

### BRIEF DESCRIPTION OF DRAWINGS

FIG. 1 is a configuration diagram showing a scenario providing system according to one embodiment of the present invention.

FIG. 2A is a diagram showing an example of a scenario executable in a scenario execution terminal according to the technology of the related art.

FIG. 2B is a diagram showing an example of a scenario executable in a scenario execution terminal according to one embodiment of the present invention.

FIG. 3 is a function block diagram showing a configuration of a scenario providing device according to the embodiment.

FIG. 4 is a function block diagram showing a configuration of the scenario execution terminal according to the embodiment.

FIG. 5 is a sequence diagram in scenario selection of the scenario providing system according to the embodiment.

FIG. 6 is a diagram showing an example of a scenario menu screen according to the embodiment.

FIG. 7 is a sequence diagram in scenario execution of the scenario providing system according to the embodiment.

### EMBODIMENTS CARRYING OUT THE INVENTION

Hereinafter, an embodiment of the present invention will be described in detail with reference to the drawings.

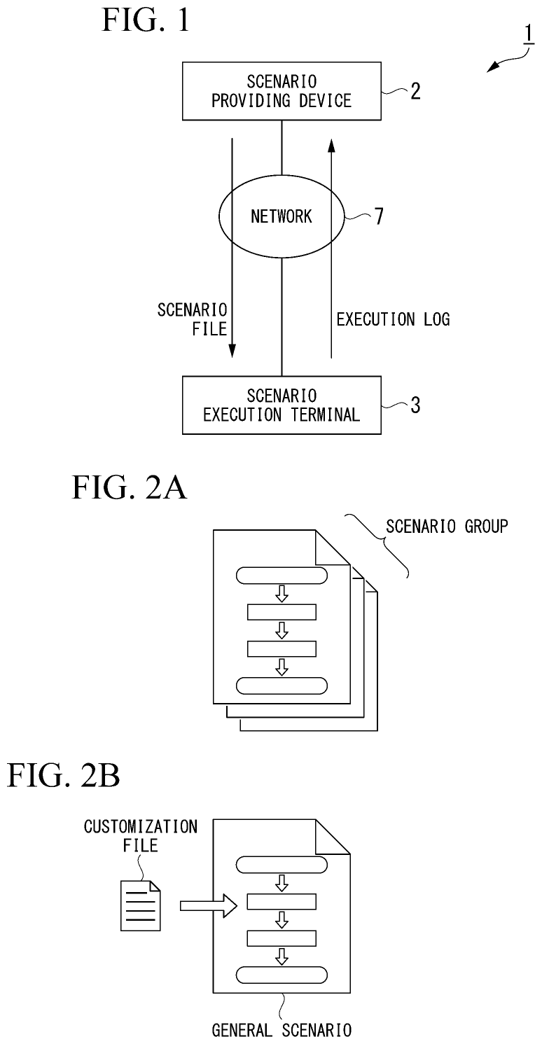

FIG. 1 is a configuration diagram of a scenario providing system 1 according to one embodiment of the present invention. The scenario providing system 1 includes a scenario providing device 2 of a business operator and a scenario execution terminal 3 of a user. While only one scenario execution terminal 3 is shown in the drawing, the number of users and the number of scenario execution terminals 3 used by each user are arbitrary. The scenario providing device 2 is connected to the scenario execution terminal 3 through a network 7 such as the Internet. Examples of the user include, but are not limited to, a company, a school, an organization, and the like.

The business operator provides scenarios of robotic process automation (RPA) to the user using the scenario providing device 2. The business operator possessing the scenario providing device 2 may create the scenarios, or a scenario provider different from the business operator may create the scenarios. The scenario execution terminal 3 is, for example, a PC. The scenario execution terminal 3 selects and downloads a scenario desired by the user from the scenarios provided by the scenario providing device 2.

FIG. 2A and FIG. 2B are diagrams showing an example of a scenario executable in the scenario execution terminal 3. FIG. 2A shows a scenario in the same statement format as in the related art. In the related art, each process is directly defined in a fixed scenario. Thus, in a case where processes that are mostly the same but partially different are included in a plurality of scenarios, each of the different processes has to be created as a separate scenario even in a case where the different processes are similar. In a case where the business operator is assumed to create and provide such a fixed scenario to the user, the number of scenarios that have to be prepared is increased. Furthermore, in order to enable the user to select a scenario, information about a difference between similar scenarios has to be provided to the user. Thus, management of the scenarios for the business operator is complicated. In addition, it is difficult for the user to select a scenario necessary for the user from multiple scenarios based on the information provided from the business operator.

FIG. 2B shows a scenario in a customizable format. The scenario shown in FIG. 2B is configured with a general scenario and a customization file. The general scenario is a scenario that is generally stated to be usable in the scenario execution terminals 3 of a plurality of users. The customization file is a slugline file for customizing the general scenario to match a usage environment of the user, an own business operation rule of the user, and the like. Each user customizes the general scenario using the customization file and causes the scenario execution terminal 3 to execute the customized scenario.

The general scenario abstracts an operation and is stated excluding a part of a variable that is a target of customization by the user. The user states a setting value of the variable in the customization file. Correction of the general scenario by the user is not necessary. In such a manner, by externalizing the part of the variable used in the scenario to the customization file, the scenario can be abstracted and integrated into one general scenario.

For example, in a scenario for creating a business travel expense document, it is considered that a website for route and fare calculation provided on the Internet is used. In a case where a plurality of such sites are present, a universal resource locator (URL) of an access destination is stated as the variable in the general scenario, and the URL of the site used by the user is stated as the value of the variable in the customization file. In addition, use or non-use of an express train that is used as an input when accessing the URL is stated as the variable in the general scenario, and use of the express train or non-use of the express train is stated as the value of the variable in the customization file. The scenario execution terminal 3 outputs a log related to execution of the scenario using the setting value to the scenario providing device 2.

In the present embodiment, the scenario providing device 2 provides the scenarios in the format shown in FIG. 2B to the scenario execution terminal 3. The scenarios provided by the scenario providing device 2 may include a scenario in the format in FIG. 2A. The scenario providing device 2 performs billing in accordance with download of the scenario (purchase of the scenario) to the scenario execution terminal 3, the number of times the scenario is executed in the scenario execution terminal 3, execution of a predetermined process in the scenario, and the like. A process of a billing target may be a process fixedly included in the scenario or a process executed using the value of the variable stated in the customization file.

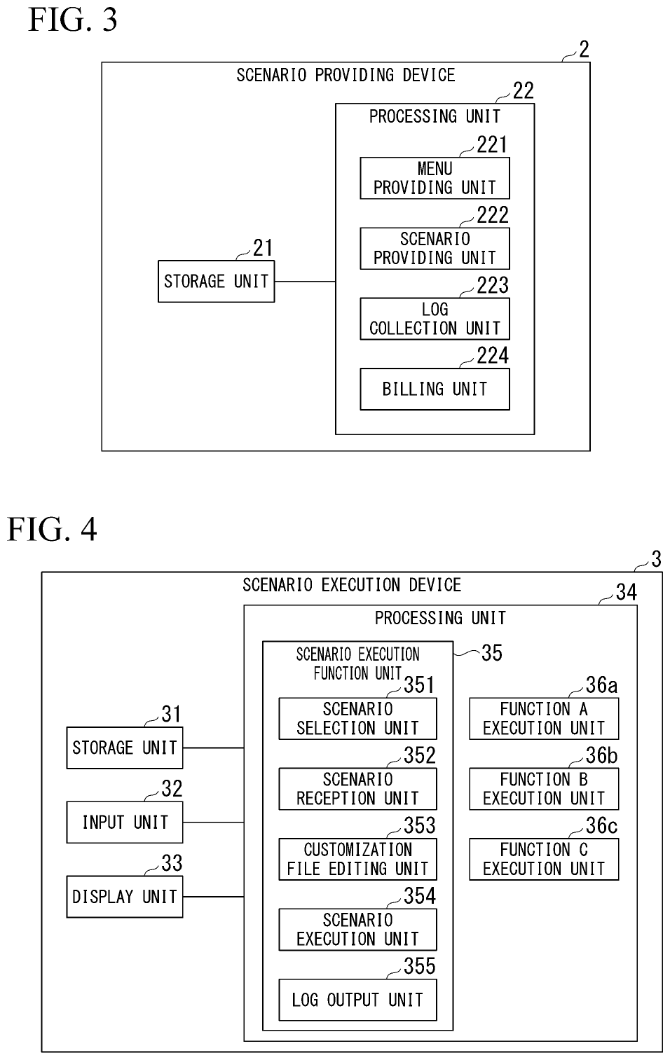

FIG. 3 is a function block diagram showing a configuration of the scenario providing device 2. The scenario providing device 2 is implemented by, for example, one or more information processing devices (computer servers) on a cloud. In a case where the scenario providing device 2 is implemented using a plurality of information processing devices communicably connected through the network 7, each function unit included in the scenario providing device 2 may be implemented in a distributed manner among the plurality of information processing devices. Which information processing device is to implement each function unit of the scenario providing device 2 can be arbitrarily decided. In addition, the same function unit may be implemented by a plurality of information processing devices.

The scenario providing device 2 includes a storage unit 21 and a processing unit 22. The storage unit 21 stores user data, a scenario selection menu, a scenario set associated with the menu, a scenario help file, log data, and billing data.

The user data indicates information related to the user using RPA. For example, the user data includes information such as a user ID, a name and a contact of the user, a license and a client ID of the scenario execution terminal 3 possessed by the user, and the like. The user ID is information for uniquely specifying the user. The license is data for permitting use of a function (hereinafter referred to as a scenario execution function) related to execution of the scenario in the scenario execution terminal 3 used by the user. The client ID is identification information assigned to the scenario execution function of the scenario execution terminal 3.

The scenario selection menu is data of a menu for selecting the scenario. In the present embodiment, a case of using a layered menu will be illustratively described. A scenario ID is associated with a menu of the lowest layer. The scenario ID is identification information for uniquely specifying the scenario set. The menu need not be layered as long as the user can select an option (menu item) for deciding the scenario.

The scenario set includes the scenario ID, a scenario file, and the customization file. The scenario file is a file in which the general scenario shown in FIG. 2B is stated. The scenario file may be a file of the scenario in the statement format in FIG. 2A. In this case, the customization file is not included in the scenario set.

For example, in a case where a threshold used in a certain determination process is stated as a variable X in the general scenario, a location in which a value of the variable X is stated is included in the customization file. The content “Please set an upper limit of an amount of money on the right side of ‘variable X=’ (example: in the case of 1000 yen, variable X=1000)” is described in a row in which the value of the variable X is stated or an upper or lower row in the customization file, or in the help file.

In addition, for example, in a case where the URL of the website accessed in a certain process is stated as a variable Y in the general scenario, a location in which a value of the variable Y is stated is included in the customization file. The content “Please write ‘http://aaa.xxx’ in the case of using a website A or ‘http://bbb.xxx’ in the case of using a website B on the right side of ‘variable Y=’” is described in a row in which the value of the variable Y is stated or an upper or lower row in the customization file, or in the help file.

As described above, a description of how the value of the variable is stated is included in the vicinity of the location in which the value of the variable is stated in the customization file. The description may include options of settable values of the variable. Accordingly, even a user not used to scenario creation can state the value of the variable in accordance with the description stated in the customization file. Accordingly, the scenario can be easily customized to match the usage environment of the user and the own business operation rule of the user.

The help file is a file in which a description related to the scenario is stated. The help file includes a function of the scenario, a function used at a time of scenario execution, and a description of how the setting value of the variable is stated in the customization file. The help file is associated with the scenario ID. The help file may be included in the scenario set.

The log data is information in which the client ID, a time, and an event are associated. The event indicates an operation performed by the scenario execution terminal 3. For example, the event includes the download of the scenario, a start of execution of the scenario, execution of a specific process in the scenario, and a scenario execution result (normal finish, abnormal finish, and the like). Processes collected as the log data when executed in the scenario include, for example, a process of executing a paid function (process of the billing target).

For example, it is assumed that an OCR service A enabling recognition of printed text and an OCR service B enabling recognition of handwritten text are present on the Internet, and that a usage fee of the OCR service B is higher than a usage fee of the OCR service A. In the general scenario, a process of transmitting image data to an OCR site and receiving a recognition result is included, and the URL of the access destination in the process is stated by the variable. In the customization file, any of a URL of a site of the OCR service A and a URL of a site of the OCR service B is stated as the setting value of the variable. In the event of the log data, the fact that access has been made to the site of the OCR service A, or that access has been made to the site of the OCR service B is set. The general scenario includes information indicating a process of a target for collecting the log data as the event at a time of execution.

In the billing data, the user ID, the client ID, the billing target, and the amount of money are stated. The billing target is download of the scenario set, execution of the scenario, execution of the paid function in the scenario, or the like. Execution of the scenario and execution of the paid function in the scenario are determined based on the log data. In a case where the fact that an execution result of the scenario indicates an error is set in the log data, billing for execution of the scenario and billing for execution of the paid function in the scenario resulting in an error are not performed, but discounting may be performed.

The processing unit 22 includes a menu providing unit 221, a scenario providing unit 222, a log collection unit 223, and a billing unit 224. The menu providing unit 221 generates screen data for displaying the menu using menu data stored in the storage unit 21 and transmits the screen data to the scenario execution terminal 3. In a case where the menu displayed on the scenario execution terminal 3 is not the menu of the lowest layer, the menu providing unit 221 selects a menu to be subsequently displayed on the scenario execution terminal 3 from the layered menu in accordance with menu selection of the user received from the scenario execution terminal 3. The menu providing unit 221 generates screen data for displaying the selected menu and transmits the screen data to the scenario execution terminal 3. Meanwhile, in a case where the menu displayed on the scenario execution terminal 3 is the menu of the lowest layer, the menu providing unit 221 decides the scenario in accordance with the menu selection of the user received from the scenario execution terminal 3.

The scenario providing unit 222 reads the scenario set of the scenario decided by the menu providing unit 221 from the storage unit 21 and transmits the scenario set to the scenario execution terminal 3. The scenario providing unit 222 may encrypt and transmit the scenario set depending on the user or the scenario execution terminal 3. The log collection unit 223 generates the log data by receiving information about the occurring event from each scenario execution terminal 3 and writes the log data into the storage unit 21. The billing unit 224 generates the billing data by referring to the event stated in the log data.

FIG. 4 is a function block diagram showing a configuration of the scenario execution terminal 3. The scenario execution terminal 3 includes a storage unit 31, an input unit 32, a display unit 33, and a processing unit 34. The storage unit 31 stores the license and the scenario set. The input unit 32 is configured using an existing input device such as a keyboard, a pointing device (a mouse, a tablet, or the like), a button, or a touch panel. The input unit 32 is operated by the user in the case of inputting an instruction of the user to the scenario execution terminal 3. The display unit 33 is an image display device such as a cathode ray tube (CRT) display, a liquid crystal display, or an organic electro luminescence (EL) display.

The processing unit 34 includes a scenario execution function unit 35 and a function X execution unit 36. The scenario execution function unit 35 includes a scenario selection unit 351, a scenario reception unit 352, a customization file editing unit 353, a scenario execution unit 354, and a log output unit 355.

The scenario selection unit 351 receives the screen data for displaying the menu from the scenario providing device 2, displays the menu on the display unit 33, and notifies the scenario providing device 2 of information about the option (menu selection) selected from the menu by the user. The scenario reception unit 352 receives the scenario set finally decided based on the menu selection of the user from the scenario providing device 2. In a case where the scenario set is encrypted, the scenario reception unit 352 decrypts the scenario set using a decryption key included in a device of the scenario reception unit 352. Then, the scenario reception unit 352 writes the scenario set into the storage unit 31. The customization file editing unit 353 edits the customization file based on an input provided by the input unit 32.

The customization file editing unit 353 can be implemented by, for example, a general text editing application or a document editing application. The scenario execution unit 354 executes the scenario generated by setting, in the general scenario indicated by the scenario file, the value of the variable stated in the customization file.

The log output unit 355 generates the log data in which the event occurring in the device of the log output unit 355 is stated, and notifies the scenario providing device 2 of the log data.

The function X execution unit 36 executes an application of a function X. The function X is a function that may be used for executing the scenario. The function X can be an arbitrary function implemented in the PC, such as mail transmission and reception, table calculation, document editing, postcard creation, figure drawing, and web browsing. In FIG. 4, the function X execution unit 36 (X=A, B, and C) executing an application of each of functions A, B, and C is described as a function A execution unit 36a, a function B execution unit 36b, and a function C execution unit 36c.

Next, an operation of the scenario providing system 1 will be described.

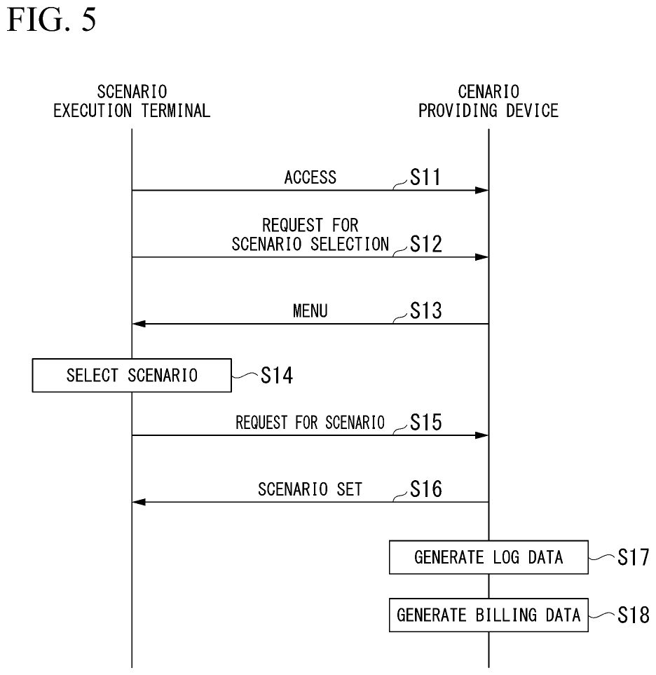

FIG. 5 is a sequence diagram in scenario selection of the scenario providing system 1. First, the scenario execution terminal 3 accesses the scenario providing device 2 by transmitting the user ID and the client ID to the scenario providing device 2 (step S11). After the access, the scenario selection unit 351 of the scenario execution terminal 3 transmits a request for scenario selection to the scenario providing device 2 (step S12). In a case where the request for scenario selection is received, the menu providing unit 221 of the scenario providing device 2 generates the screen data for displaying the menu using the menu data stored in the storage unit 21 and transmits the screen data to the scenario execution terminal 3 (step S13).

The user selects the scenario by causing the scenario selection unit 351 of the scenario execution terminal 3 to gradually select the menu displayed on the display unit 33 (step S14). The scenario selection unit 351 makes a request for download of the selected scenario to the scenario providing device 2 (step S15). The scenario providing unit 222 of the scenario providing device 2 reads, from the storage unit 21, the scenario set for which the request for download is made, encrypts the scenario set, and transmits the scenario set to the scenario execution terminal 3 (step S16). The scenario reception unit 352 of the scenario execution terminal 3 decrypts the scenario set received from the scenario providing device 2 and writes the scenario set into the storage unit 31.

The log collection unit 223 of the scenario providing device 2 generates the log data in which the user ID, the client ID, the scenario ID of the downloaded scenario set, and a download time are set, and writes the log data into the storage unit 21 (step S17). The billing unit 224 of the scenario providing device 2 generates, based on the log data, billing information in which the user ID, the client ID, the scenario ID, the amount of money for the scenario, and the download time are set, and writes the billing information into the storage unit 21 (step S18).

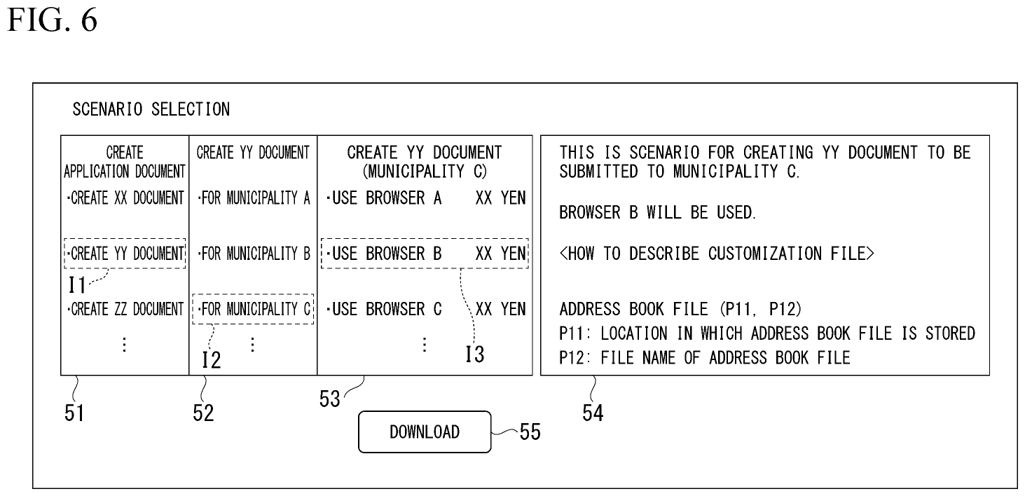

FIG. 6 is a diagram showing an example of a scenario menu screen displayed on the scenario execution terminal 3 by the menu providing unit 221 of the scenario providing device 2. The user selects the desired scenario using the menu screen.

In a case where the request for scenario selection is received from the scenario execution terminal 3, the menu providing unit 221 of the scenario providing device 2 reads screen data for displaying a first layer menu 51 from the storage unit 21 and transmits the screen data to the scenario execution terminal 3. The first layer menu 51 is a menu for selecting a large category of the scenario. The scenario selection unit 351 of the scenario execution terminal 3 displays the first layer menu 51 on the display unit 33 using the screen data received from the scenario providing device 2. The scenario selection unit 351 transmits information about an item I1 selected from the first layer menu 51 by the user using the input unit 32 to the scenario providing device 2.

The menu providing unit 221 of the scenario providing device 2 reads screen data for displaying a second layer menu 52 corresponding to the selected item I1 from the storage unit 21 and transmits the screen data to the scenario execution terminal 3. The scenario selection unit 351 of the scenario execution terminal 3 displays the second layer menu 52 on the display unit 33 using the screen data received from the scenario providing device 2. The scenario selection unit 351 transmits information about an item I2 selected from the second layer menu 52 by the user using the input unit 32 to the scenario providing device 2.

The menu providing unit 221 of the scenario providing device 2 reads screen data for displaying a third layer menu 53 corresponding to the selected item I2 from the storage unit 21 and transmits the screen data to the scenario execution terminal 3. The scenario selection unit 351 of the scenario execution terminal 3 displays the third layer menu 53 on the display unit 33 using the display screen data received from the scenario providing device 2. The scenario selection unit 351 transmits information about an item I3 selected from the third layer menu 53 by the user using the input unit 32 to the scenario providing device 2.

In a case where the scenario is decided in accordance with the selected item I3, the menu providing unit 221 of the scenario providing device 2 reads screen data for displaying the help file of the scenario from the storage unit 21 and transmits the screen data to the scenario execution terminal 3. The scenario selection unit 351 of the scenario execution terminal 3 displays a help file display screen 54 on the display unit 33 using the screen data received from the scenario providing device 2.

The user views the description related to the scenario, how to set the customization file, and the like displayed on the help file display screen 54, and upon deciding to use the scenario, selects a download button 55 using the input unit 32. The scenario selection unit 351 of the scenario execution terminal 3 transmits the request for download to the scenario providing device 2. The scenario providing unit 222 of the scenario providing device 2 reads the scenario set of the scenario decided by the menu providing unit 221 from the storage unit 21, encrypts the scenario set, and transmits the scenario set to the scenario execution terminal 3.

While the menu includes three layers above, the number of layers can be an arbitrary number of one or greater, and the number of layers until the scenario is decided may vary depending on the option in the menu of each layer. In addition, the function of the scenario is included in the first layer menu 51 and the second layer menu 52 as the item of the menu, and which application is to be used by the scenario execution terminal 3 for performing the function used in the scenario is included in the third layer menu 53 as the item of the menu. However, other information may be used as the item of the menu for selecting the scenario. For example, a scenario execution environment in the scenario execution terminal 3, such as a type of operation system (OS) or a size of a display implemented in the scenario execution terminal 3, or the website accessed in the scenario may be used for selecting the scenario.

Even in a case where the function of the scenario is the same, a scenario for each factor is created in a case where a factor preventing commonization of the scenario by setting the variable is present. Thus, the factor preventing commonization is used as the item of the menu. For example, in the example in FIG. 6, in a case where the function of the scenario of creating an XX document for a municipality C is the same, but a type of browser used by the scenario execution terminal 3 is different, a part of a process in the scenario cannot be commonized by setting the variable. Thus, the type of browser is included as the item of the menu in order to create the scenario for each type of browser. Meanwhile, in a case where the general scenario in which any of a plurality of types of browsers is usable can be created, the type of browser is not included as the item of the menu.

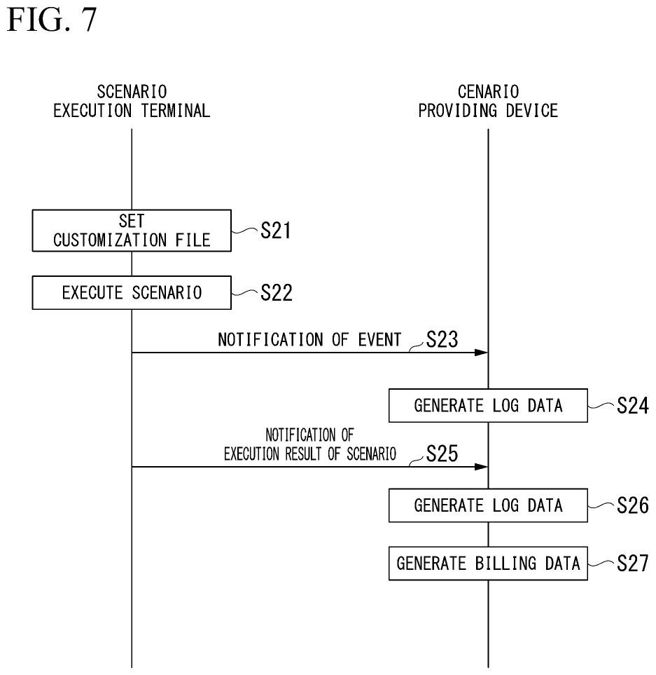

FIG. 7 is a sequence diagram in scenario execution of the scenario providing system 1. The customization file editing unit 353 of the scenario execution terminal 3 reads the customization file of the scenario selected by the user using the input unit 32 from the storage unit 31 and displays the customization file. Furthermore, the customization file editing unit 353 may read the help file of the scenario from the scenario providing device 2 or from the scenario set and display the help file on the display unit 33. The customization file editing unit 353 stores an updated customization file in the storage unit 31 by writing the value of the variable input by the user using the input unit 32 into the displayed customization file (step S21).

In a case where the user selects the scenario and inputs an execution instruction using the input unit 32, the scenario execution unit 354 executes the scenario using the scenario file of the scenario of a target of the execution instruction and the updated customization file (step S22). The user may edit a plurality of customization files in which at least a part of the setting value is different, store the customization files in the storage unit 31, and input selection of the customization file to be used using the input unit 32. The scenario execution unit 354 creates an execution scenario file by substituting, in the general scenario stated in the scenario file of the designated scenario, the setting value stated in the customization file, stores the execution scenario file in the storage unit 31, and executes the execution scenario file. Alternatively, each time the process using the variable in the general scenario stated in the scenario file is executed, the scenario execution unit 354 reads the setting value of the variable from the customization file, substitutes the setting value, and executes the execution scenario file.

The scenario execution unit 354 transmits, to the scenario providing device 2, an event notification indicating that a predetermined process is executed in scenario execution (step S23). The event notification includes information such as the user ID, the client ID, the scenario ID of the executed scenario, a type of event, and an event occurrence time. The log collection unit 223 of the scenario providing device 2 generates the log data using the information included in the event notification and writes the log data into the storage unit 21 (step S24).

In addition, in a case where execution of the scenario is finished, the scenario execution unit 354 of the scenario execution terminal 3 transmits a scenario execution result notification to the scenario providing device 2 (step S24). The scenario execution result notification includes information such as the user ID, the client ID, the scenario ID of the executed scenario, the execution result of the scenario, and an execution finish time. The log collection unit 223 of the scenario providing device 2 generates the log data using the information included in the scenario execution result notification and writes the log data into the storage unit 21 (step S26).

The scenario execution unit 354 may perform the notification for each predetermined cycle without notifying the scenario providing device 2 with the event notification and the scenario execution result notification each time.

The billing unit 224 of the scenario execution terminal 3 generates the billing information based on the log data generated for each predetermined time period in step S24 and the log data generated in step S26, and writes the billing information into the storage unit 21 (step S27). In the billing information based on the log data generated in step S24, the user ID, the client ID, the scenario ID, the event, the amount of money corresponding to the event, and the event occurrence time are set. In the billing information based on the log data generated in step S26, the user ID, the client ID, the scenario ID, the amount of money corresponding to the scenario ID and the scenario execution result, and the execution finish time are set. The billing unit 224 may generate the billing data with each generation of the log data.

In the embodiment, the customization file is directly edited in the scenario execution terminal 3. However, the scenario providing device 2 may receive the setting value of the variable from the scenario execution terminal 3, generate the customization file using the received setting value, and transmit the customization file to the scenario execution terminal 3. For example, the scenario providing unit 222 of the scenario providing device 2 transmits, to the scenario execution terminal 3, setting value input screen data for inputting the setting value of each variable to be set in the customization file of the scenario for which the request for download is made from the scenario execution terminal 3. The user inputs, using the input unit 32, the setting value into a setting value input field of each variable in the setting value input screen data displayed on the display unit 33 of the scenario execution terminal 3 and provides an input indicating completion of setting. A description of what the variable represents and how the value of the variable is stated is included in the vicinity such on the right or left or in a row above or below the setting value input field of each variable. In the setting value input field, an arbitrary value may be input, or an input may be provided by selecting a possible value from a setting value list. The scenario execution terminal 3 transmits the setting value input in the setting value input field of each variable to the scenario providing device 2. The scenario providing unit 222 of the scenario providing device 2 states the setting value received from the scenario execution terminal 3 in the setting value of each variable of the customization file and transmits the customization file to the scenario execution terminal 3.

According to the embodiment, for a potential user not used to programming, the scenario providing device 2 provides, to the scenario execution terminal 3 of the user, a scenario that is can be customized for each individual user when used by stating a value in the customization file. Accordingly, a concern of the potential user about difficulty of scenario creation can be resolved, and introduction of RPA can be promoted.

In addition, a usage environment of the PC, a size of a screen, an implemented application, condition setting such as a numerical value, and the like are different for each user. In a case where it is assumed that all of the number of scenarios corresponding to a combination thereof are prepared, an enormous number of scenarios have to be prepared in the scenario providing device 2, and it is also difficult for the user to correctly select the scenario to be used by the user from the scenarios. According to the present embodiment, the general scenario that is a scenario obtained by extracting a part having a certain degree of commonality is created and combined with the customization file that can be customized in accordance with an intention. Thus, the number of scenarios to be prepared can be reduced.

However, even in a case where the component of the general scenario is combined with the customization file, it is necessary for the user to set the customization file. Therefore, in order to improve convenience of use, the setting value to be used in the scenario is written in advance in an environment in which the scenario operates, and different setting is enabled even for the same operation by simply referring to the setting value stated in the customization scenario instead of selecting which setting value is to be used with each execution of the scenario. Accordingly, the general scenario in which a basic operation is abstracted can be used, and the user can easily use a scenario having an intended function by causing the user to state the setting value in the customization file.

Functions of the scenario providing device 2 and the scenario execution terminal 3 in the embodiment may be implemented by a computer. In this case, the functions may be implemented by recording a program for implementing the functions on a computer-readable recording medium, reading the program recorded on the recording medium into a computer system, and executing the program. Here, it is assumed that the “computer system” includes an OS and hardware such as a peripheral device. In addition, “computer-readable recording medium” refers to a portable medium such as a flexible disk, a magneto-optical disc, a read-only memory (ROM), or a compact disc read-only memory (CD-ROM), or a storage device such as a hard disk incorporated in the computer system. Furthermore, the “computer-readable recording medium” may include a medium dynamically holding the program for a short time period, such as a communication line in the case of transmitting the program through a network such as the Internet or a communication line such as a telephone line, and a medium holding the program for a certain time period, such as a volatile memory inside the computer system used as a server or a client in the case of transmitting the program. In addition, the program may be a program implementing a part of the functions, or furthermore, a program capable of implementing the functions in combination with a program already recorded in the computer system.

According to the embodiment described above, a scenario providing system includes a scenario providing device and a scenario execution terminal. The scenario providing device includes a storage unit, a menu providing unit, and a scenario providing unit. The storage unit stores a scenario file in which a scenario indicating a procedure of a process in the scenario execution terminal is stated, a customization file for stating a setting value of a variable used for executing the process constituting the scenario stated in the scenario file, and a menu for selecting the scenario. The customization file may include a statement of a description related to the setting value of the variable. The menu providing unit causes the scenario execution terminal to display the menu and decides the scenario in accordance with an option selected in the scenario execution terminal from options included in the displayed menu. In a case where the menu is layered, the menu providing unit causes the scenario execution terminal to display the menu and repeats, until the scenario is decided, a process of, in a case where the displayed menu is not a lowest layer, causing the scenario execution terminal to display a menu of an immediately lower layer decided in accordance with the option selected in the scenario execution terminal from the options included in the menu and, in a case where the displayed menu is the lowest layer, deciding the scenario in accordance with the option selected in the scenario execution terminal from the options included in the menu. The scenario providing unit transmits the scenario file of the scenario decided by the menu providing unit and the customization file to the scenario execution terminal.

The scenario execution terminal includes a scenario selection unit, a scenario reception unit, and a scenario execution unit. The scenario selection unit displays the menu received from the scenario providing device on a display unit and notifies the scenario providing device of the option selected from the menu. The scenario reception unit receives the scenario file and the customization file from the scenario providing device. A customization file editing unit performs editing of setting a value of the variable in the customization file in accordance with an input provided by a user. The scenario execution unit substitutes, in the scenario indicated by the scenario file, the setting value of the variable stated in the customization file and executes the scenario in which the setting value is substituted.

The customization file may include a statement of a description related to the setting value of the variable. In addition, in the menu, one or more of a function of the scenario, an application implementing a function used in the scenario in the scenario execution terminal, an execution environment (a type of OS, a size of a display, and the like) of the scenario in the scenario execution terminal, and an external service used in the scenario may be used as the options.

In addition, the scenario execution terminal may further include a log output unit configured to output log data indicating execution of a predetermined process included in the scenario or an execution result of the scenario to the scenario providing device. In this case, the scenario providing device may further include a billing unit configured to perform billing based on the log data received from the scenario execution terminal.

While an embodiment of the invention has been described above in detail with reference to the drawings, a specific configuration is not limited to the embodiment, and the invention also includes a design and the like not departing from a gist of the invention.

### REFERENCE SIGNS LIST

1: Scenario providing system

2: Scenario providing device

3: Scenario execution terminal

7: Network

21: Storage unit

22: Processing unit

31: Storage unit

32: Input unit

33: Display unit

34: Processing unit

35: Scenario execution function unit

36a: Function A execution unit

36b: Function B execution unit

36c: Function C execution unit

221: Menu providing unit

222: Scenario providing unit

223: Log collection unit

224: Billing unit

351: Scenario selection unit

352: Scenario reception unit

353: Customization file editing unit

354: Scenario execution unit

355: Log output unit

1. A scenario providing system comprising:
a scenario providing device; and
a scenario execution terminal,
the scenario providing device including
a storage unit configured to store a scenario file in which a scenario indicating a procedure of a process in the scenario execution terminal is stated, a customization file for stating a setting value of a variable used for executing the process constituting the scenario stated in the scenario file, and a menu for selecting the scenario,
a menu providing unit configured to cause the scenario execution terminal to display the menu and decide the scenario in accordance with the option selected in the scenario execution terminal from options included in the displayed menu, and
a scenario providing unit configured to transmit the scenario file of the scenario decided by the menu providing unit and the customization file to the scenario execution terminal, and
the scenario execution terminal including
a scenario selection unit configured to display the menu received from the scenario providing device on a display unit and notify the scenario providing device of the option selected from the menu,
a scenario reception unit configured to receive the scenario file and the customization file from the scenario providing device,
a customization file editing unit configured to perform editing of setting a value of the variable in the customization file in accordance with an input provided by a user, and
a scenario execution unit configured to substitute, in the scenario indicated by the scenario file, the setting value of the variable stated in the customization file and execute the scenario in which the setting value is substituted.

2. The scenario providing system according to claim 1,
wherein the customization file includes a statement of a description related to the setting value of the variable.

3. The scenario providing system according to claim 1,
wherein, in the menu, one or more of a function of the scenario, an application implementing a function used in the scenario in the scenario execution terminal, an execution environment of the scenario in the scenario execution terminal, and an external service used in the scenario are used as the options.

4. The scenario providing system according to a claim 1,
wherein the scenario execution terminal further includes a log output unit configured to output log data indicating execution of a predetermined process included in the scenario or an execution result of the scenario to the scenario providing device.

5. The scenario providing system according to claim 4,
wherein the scenario providing device further includes a billing unit configured to perform billing based on the log data received from the scenario execution terminal.

6. A scenario providing device in a scenario providing system including the scenario providing device and a scenario execution terminal, the scenario providing device comprising:
a storage unit configured to store a scenario file in which a scenario indicating a procedure of a process in the scenario execution terminal is stated, a customization file for stating a setting value of a variable used for executing the process constituting the scenario stated in the scenario file, and a menu for selecting the scenario;
a menu providing unit configured to cause the scenario execution terminal to display the menu and decide the scenario in accordance with the option selected in the scenario execution terminal from options included in the displayed menu; and
a scenario providing unit configured to transmit the scenario file of the scenario decided by the menu providing unit and the customization file to the scenario execution terminal.

7. A scenario execution terminal in a scenario providing system including a scenario providing device and the scenario execution terminal, the scenario execution terminal comprising:
a scenario selection unit configured to receive a menu for selecting a scenario indicating a procedure of a process in the scenario execution terminal from the scenario providing device, display the menu on a display unit, and notify the scenario providing device of an option selected from the menu;
a scenario reception unit configured to receive, from the scenario providing device, a scenario file in which the scenario decided in accordance with the option is stated, and a customization file for stating a setting value of a variable used for executing the process constituting the scenario stated in the scenario file;
a customization file editing unit configured to perform editing of setting a value of the variable in the customization file in accordance with an input provided by a user; and
a scenario execution unit configured to substitute, in the scenario indicated by the scenario file, the setting value of the variable stated in the customization file and execute the scenario in which the setting value is substituted.

8. (canceled)

9. (canceled)

10. (canceled)

11. (canceled)

12. (canceled)
